(19) United States
(12) Patent Application Publication
(10) Pub. No.: US 2026/0066573 A1
(43) Pub. Date: Mar. 5, 2026

(54) ELECTRONIC PORT SUPPORT APPARATUS

(71) Applicants: Leisa-Marie Hume, Durham, NC (US); Ann-Drea Small, Durham, NC (US)

(72) Inventors: Leisa-Marie Hume, Durham, NC (US); Ann-Drea Small, Durham, NC (US)

(21) Appl. No.: 18/819,715

(22) Filed: Aug. 29, 2024

(51) Int. Cl. H01R 13/516; G06F 1/16

(52) U.S. Cl. CPC H01R 13/516; G06F 1/1656

(57) ABSTRACT

The invention is a support apparatus that can be used to reinforce the physical communication ports on an associated electronic device to prevent damage due to impact or everyday use. The protective apparatus includes an outer protective housing that physically surrounds a communications port. The apparatus also includes an attachment that releasably or permanently connects to the housing. The attachment functions to retain the port within the interior of the housing cavity. Once the apparatus is configured around the communications port, it is protected from damage.

### FIELD OF THE INVENTION

The presently disclosed subject matter is directed to a support apparatus used with a port of an electronic device. Specifically, the apparatus can be used for reinforcing physical communication ports on associated electrical devices, such as gaming consoles and computers.

### BACKGROUND OF THE INVENTION

In recent years, the use of computing devices such as laptop computers, gaming consoles, and similar items has become widespread. Advantageously, the devices are portable and thus allow for computing, gaming, and data processing operations on the go and at remote locations. Communications ports have contributed significantly to the advancement in portable computing devices. Specifically, communication ports are configured in portable devices, providing a virtual point where network connections start and end. Each port can be associated with a specific process or service. Thus, communications ports allow portable devices to connect to accessory items, such as cameras, keyboards, monitors, and the like. However, portable computing devices are subject to being dropped during normal use or while being transported from location to location, thereby damaging the communications port. Other impact-related damage can occur due to the reduced size and interactive nature of the electronic devices, as commonly seen with gaming consoles. As a result, communications ports are often damaged, requiring costly and time-consuming repairs. It would therefore be desirable to provide an apparatus that can mitigate or eliminate port damage during routine use and contact with an associated electronic device.

### SUMMARY OF THE INVENTION

In some embodiments, the presently disclosed subject matter is directed to protective apparatus. Specifically, the protective apparatus comprises a housing defined by a front face comprising one or more apertures, a rear face, a pair of side faces, a top face and an opposed bottom face, and a cavity that extends into an interior of the housing from the front face. The apparatus includes an attachment defined by a front face and an opposed rear face, the rear face comprising one or more projections aligned with the one or mor apertures of the housing, a pair of side faces, a top face and an opposed bottom face, and an opening that extends through a thickness of the attachment. The bottom face of the attachment includes a lowered region comprising a ledge that extends away from the rear face of the attachment. The housing and attachment are releasably joined together by positioning the projections in the aligned apertures.

In some embodiments, the presently disclosed subject matter includes a communications port positioned within the cavity.

In some embodiments, the communications port is selected from a HDMI (High Definition Multimedia Interface) port, 11. USB (Universal Serial Bus) port, or ethernet port.

In some embodiments, the housing rear face includes an indentation that extends into the cavity.

In some embodiments, the protective apparatus includes two apertures and two projections.

In some embodiments, the housing has a length and width of about 0.25-2 inches and a height of about 0.1-1 inches.

In some embodiments, the ledge is positioned below the bottom face of the housing.

In some embodiments, the attachment has a length and height of 0.25-2 inches and a width of 0.1-0.5 inches.

In some embodiments, the ledge has a length, width, or both of about 0.1-1 inches.

In some embodiments, the protective device is constructed from one or more of metal, plastic, rubber, or composite materials. The term “metal” refers to an electropositive chemical element. The term “plastic” refers to any synthetic or naturally occurring material or combination of materials that can be molded or shaped, generally when heated and hardened into a desire shape. The term “rubber” refers to any elastic polymeric materials. The term “composite materials” refers to structural fibers impregnated with a compatible synthetic resin for making a molded structure of resin impregnated fibrous material.

In some embodiments, the presently disclosed subject matter is directed to a method of preventing or reducing the incidence of damage to a communications port of an electronic device. Particularly, the method comprises positioning the communications port within the cavity of the housing of the protective apparatus. The method includes joining the attachment to the housing by positioning the one or more attachment projections within the one or more aligned housing apertures. The communications port is surrounded by the protective apparatus and wherein the communications port can be accessed via the attachment opening.

In some embodiments, the electronic device is selected from a gaming console, personal computer, tablet computing device, or electronic reader.

In some embodiments, the communications port rests upon the ledge.

### BRIEF DESCRIPTION OF THE DRAWINGS

FIG. 1 is a perspective view of an electronic device and corresponding communications port in accordance with some embodiments of the presently disclosed subject matter.

FIGS. 2a-2c are front plan views of various types of communication ports in accordance with some embodiments of the presently disclosed subject matter.

FIG. 2d is a perspective view of a computer comprising a plurality of communications ports in accordance with some embodiments of the presently disclosed subject matter.

FIG. 3a is a front perspective view of a protective apparatus in accordance with some embodiments of the presently disclosed subject matter.

FIG. 3b is a bottom perspective view of a protective apparatus in accordance with some embodiments of the presently disclosed subject matter.

FIG. 4a is a front perspective view of a protective apparatus housing in accordance with some embodiments of the presently disclosed subject matter.

FIG. 4b is a bottom perspective view of a protective apparatus housing in accordance with some embodiments of the presently disclosed subject matter.

FIG. 4c is a cross-sectional view of a protective apparatus and HDMI in accordance with some embodiments of the presently disclosed subject matter.

FIG. 5a is a cross-sectional view taken between the front and rear faces of a protective apparatus housing in accordance with some embodiments of the presently disclosed subject matter.

FIG. 5b is a cross-sectional view taken between the top and bottom faces of a protective apparatus housing in accordance with some embodiments of the presently disclosed subject matter.

FIG. 6a is a front perspective view of a protective apparatus attachment in accordance with some embodiments of the presently disclosed subject matter.

FIG. 6b is a rear perspective view of a protective apparatus attachment in accordance with some embodiments of the presently disclosed subject matter.

FIG. 7a is a cross-sectional view taken between the top and bottom faces of an apparatus attachment in accordance with some embodiments of the presently disclosed subject matter.

FIG. 7b is a cross-sectional view taken between the front and rear faces of an apparatus attachment in accordance with some embodiments of the presently disclosed subject matter.

FIG. 8 is a perspective view of a protective apparatus configured around a communications port in accordance with some embodiments of the presently disclosed subject matter.

### DETAILED DESCRIPTION OF THE INVENTION

For the purpose of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

The presently disclosed subject matter is directed to a support apparatus that can be used to reinforce the physical communication ports on an associated electronic device to prevent damage due to impact or everyday use. The term “electronic device” refers to any device that includes electronic circuitry (i.e., active circuitry comprising an electronic element or multiple electronic elements connected by electrical connections). In some embodiments, a suitable electronic device can include a processor and a non-transitory, computer-readable medium (i.e., memory). The memory may comprise programming instructions in the form of a software application that, when executed by the processor, causes the device to perform one or more processing operations according to the programming instructions. An electronic device also may include additional components such as a touch-sensitive display device that serves as a user interface, as well as a camera or other image capturing device. An electronic device also may include one or more communication hardware components such as a transmitter to enable the device to send signals to other devices or a receiver to receive signals from other devices, whether via a communications network or via near-field or short-range communication protocols

Representative examples of electronic devices include (but are not limited to) gaming consoles, personal computers, tablet computing devices, electronic readers, printers, scanners, modems, and the like.

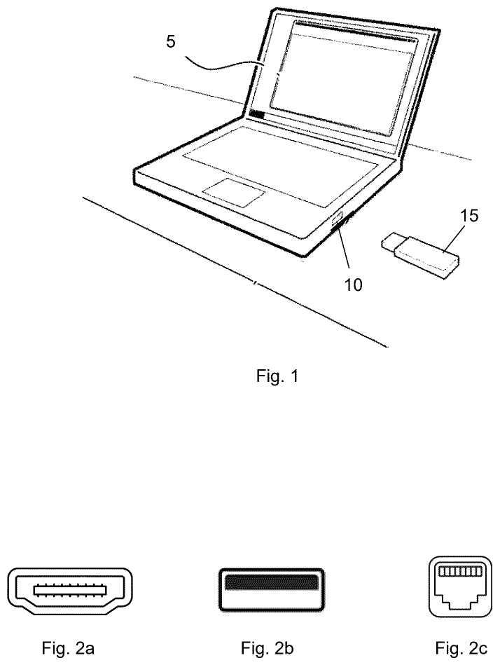

The electronic device can include at least one communication port, as illustrated in FIG. 1. As shown, electronic device 5 (e.g., a computer) includes communication port 10 (a USB port, for example) positioned on one face of the device. The port communicates with an associated drive or cable 15 (e.g., USB drive). The term “communication port” refers to a hardware interface on an electronic device that allows users to connect external devices for data transfer, power, and the like. Each port may be reserved or designated for different types of network traffic.

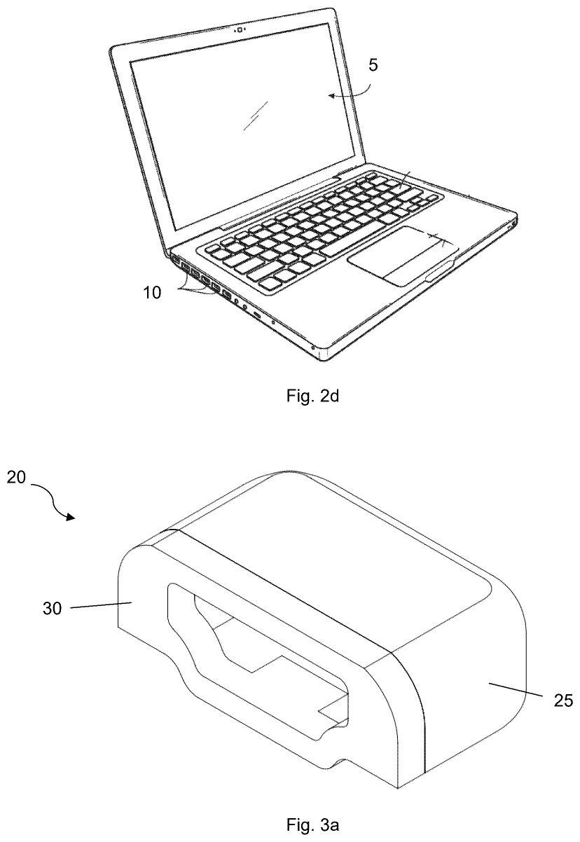

Non-limiting examples of communication ports include HDMI, USB (USB-A, USB-B, USB-C, micro USB, mini USB), DVI-D (Digital Visual Interface), DVI-I, parallel, firewire, audio (PC), audio (MAC®), PS/2, VGA (Video Graphics Array), and ethernet ports. A HDMI (High Definition Multimedia Interface) port is an audio/video interface for transmitting uncompressed video data and compressed and/or uncompressed digital audio data. HDMI ports are often used to connect devices such as satellite receivers, DVD players, computers to a compatible device such as a television or monitor. HDMI is a digital replacement for analog video standards. To this end, HDMI ports allow for high definition signals to be sent over a single cable. One example of a HDMI port is illustrated in FIG. 2a.

A USB-A is the most commonly known USB type, mainly used for wired mice and keyboards and USB sticks. A USB-B port is narrower than the USB-A port, and includes a small rectangular hole in the center, commonly used with printers, routers, and scanners. The USB-C port includes a smaller and flatter male port with a hole in the middle of the port where small connector pins will be inserted, used with mobile phones, MacBook®, iMac®, etc. The USB mini are smaller counterparts of USB-A and USB-B, found in portable cameras and game controllers. The USB Micro is commonly used with smartphones.

USB (Universal Serial Bus) ports provide a connection point for charging a device or transferring data between two devices. Specifically, USB ports standardize the connection of peripherals to electronic devices to exchange data and supply electric power. Suitable peripherals can include keyboards, mice, video cameras, printers, portable media players, disk drives, network adapters, and phones. One example of a representative USB port is illustrated in FIG. 2b.

Ethernet ports include family of wired computer networking technologies commonly used in local area networks (LAN), metropolitan area networks (MAN) and wide area networks (WAN). Thus, an ethernet port is a networking interface that is found in networking devices that allows computers and other electronic devices to connect to a network using a cable. The function of an ethernet port is to provide a connection between a networking device and the terminated ethernet cable for networking. The ports are used to connect computers and other networking components to the LAN or internet. One example of an ethernet port is illustrated in FIG. 2c.

Although the specific term “communications port” is used throughout the description, the presently disclosed subject matter is not limited to any particular port or type of port or connector. As shown in FIG. 2d, the communications ports are housed within an interior of electronic device 5, with an access positioned on a surface of the device, allowing a user to connect to the port as needed.

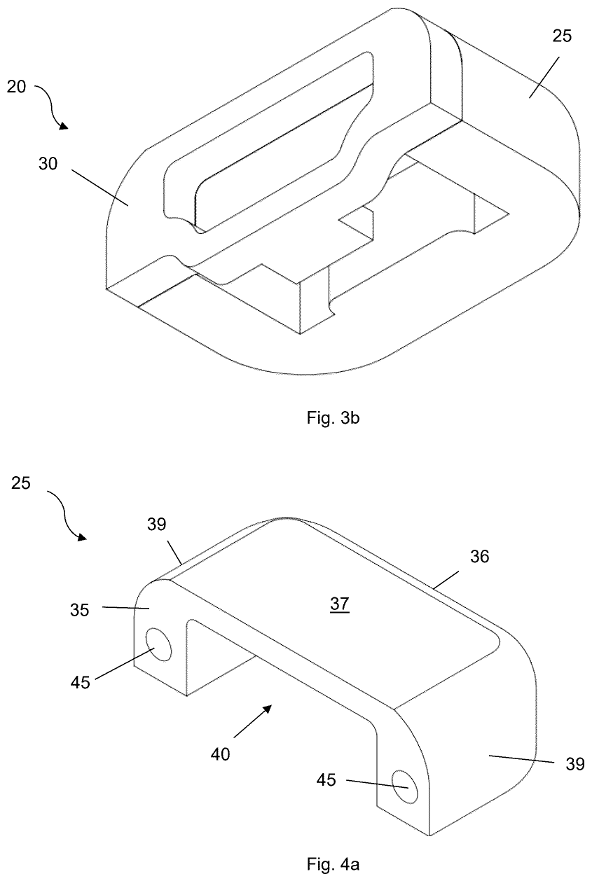

As noted above, the disclosed protective apparatus can be used to shield the device communications port, preventing or reducing the incidence of damage during use or when the electronic device is subject to inadvertent falls or drops. As illustrated in FIGS. 3a and 3b, protective apparatus 20 includes outer protective housing 25 that physically surrounds communications port 15. The apparatus also includes attachment 30 that releasably or permanently connects to the main housing. The attachment functions to retain the port within the interior of the housing as explained below.

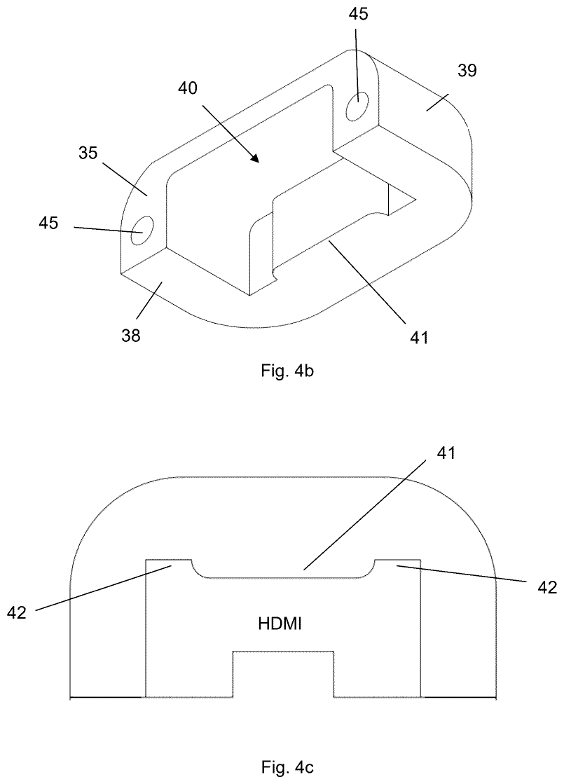

FIGS. 4a and 4b illustrate one embodiment of attachment housing 25 that is adapted to protectively encase a communications port. As shown, the housing includes front face 35 and opposed rear face 36. The housing also includes top face 37 and opposed bottom face 38. The housing further includes a pair of side faces 39. Front face 35 abuts the attachment when the protective apparatus is fully assembled, as illustrated in FIGS. 3a and 3b.

The housing includes cavity 40 that extends from front face 35 into the interior of the housing. The term “cavity” refers to any receptacle sized and shaped to receive the communications port. The cavity can be approximately rectangular in shape in some embodiments to accommodate the communications port. As illustrated in FIG. 4b, rear face 36 includes extended region 41 that extends into the cavity. The extended region can contact an enclosed communications port, ensuring a secure and snug fit within cavity 40. In addition, the extended region holds the HDMI connector pins. The indentations on each side of the extended region accommodate legs 42 of the HDMI port during use, as shown in FIG. 4c.

The front face includes one or more apertures 45 that extend into the interior of the housing. The apertures cooperate with corresponding projections positioned on the attachment, allowing the two components of the protective apparatus to be joined together. Apertures 45 can have any suitable shape, such as circular, oval, square, rectangular, triangular, and the like. It should be appreciated that the cross-sectional shape and size of the apertures should be about the same as the corresponding attachment projections, allowing the housing and attachment to be joined together for a desired amount of time.

Housing bottom face 38 can be approximately planar in some embodiments, allowing it to rest evenly on a flat surface, such as a motherboard. Opposed top face 37 can be about parallel to the bottom face in some embodiments.

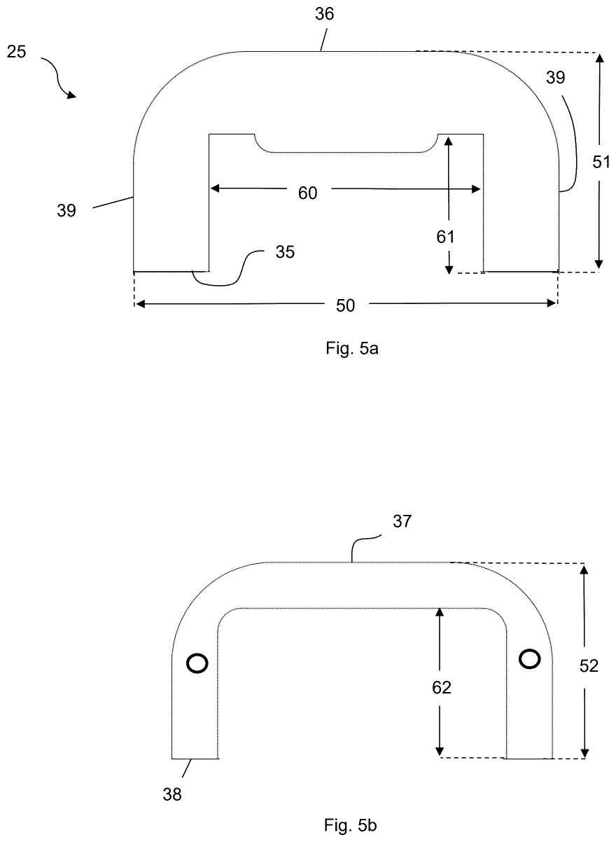

The housing can have any suitable dimensions. For example, the housing can include length 50 and/or width 51 of about 0.25-2 inches, as shown in FIG. 5a. The housing can thus have a length and/or width of at least about (or no more than about) 0.25, 0.5, 0.75, 1, 1.25, 1.5, 1.75, or 2 inches. The term “length” refers to the longest straight line horizontal distance of the housing (e.g., between side faces 39). The term “width” refers to the longest straight line distance between front and rear faces 35 and 36, as shown.

Housing 25 also includes height 52 of about 0.1-1 inches (e.g., at least/no more than about 0.1, 0.2, 0.3, 0.4, 0.5, 0.6, 0.7, 0.8, 0.9, or 1.0 inch). The term “height” includes the longest vertical distance of the housing, between top and bottom faces 37 and 38, as shown in FIG. 5b.

Housing cavity 40 can include length 60, width 61, and/or thickness 62 of about 0.1-0.8 inches (e.g., at least/no more than about 0.1, 0.2, 0.3, 0.4, 0.5, 0.6, 0.7, 0.8 inches), as shown in FIGS. 5a and 5b.

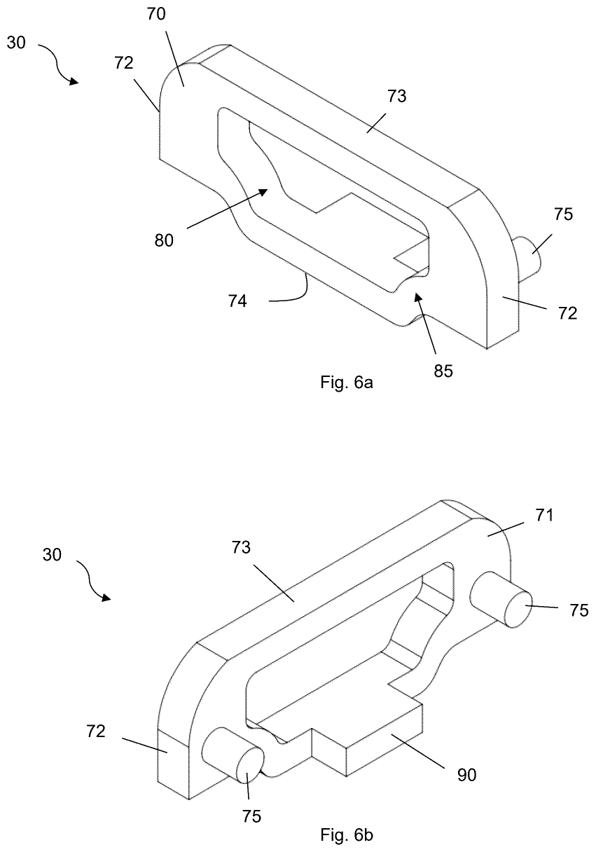

As noted above, the housing cooperates with attachment 30 to create protective apparatus 20. One embodiment of attachment 30 is illustrated in FIGS. 6a and 6b. As shown, the attachment includes front face 70 and opposed rear face 71, a pair of side edges 72, and top and bottom faces 73, 74.

Rear face 71 of the attachment is flush with and contacts front face 35 of the housing. To this end, the rear attachment face includes one or more projections 75 sized and shaped to fit into apertures 45 of the housing. In this way, the housing and attachment can be joined together and/or removed as desired by a user.

The attachment also includes central opening 80 that spans the thickness of the attachment. The central opening is sized and shaped to allow access to port 20 when the protective apparatus is enclosed around the port. As shown, the opening tapers inward at sections 85 adjacent to bottom face 74, thereby ensuring that the port remains securely in place within the apparatus cavity 40 (e.g., the tapered regions of the opening prevent the port from becoming dislodged during impact). The tapered regions also create a lowered section that is used to support the port.

Bottom face 74 of the attachment includes ledge 90 that extends from rear face 71 towards the housing and is positioned within the housing cavity. The ledge is also positioned to be below the bottom face of the housing to allow port 20 to rest upon and be supported by the ledge.

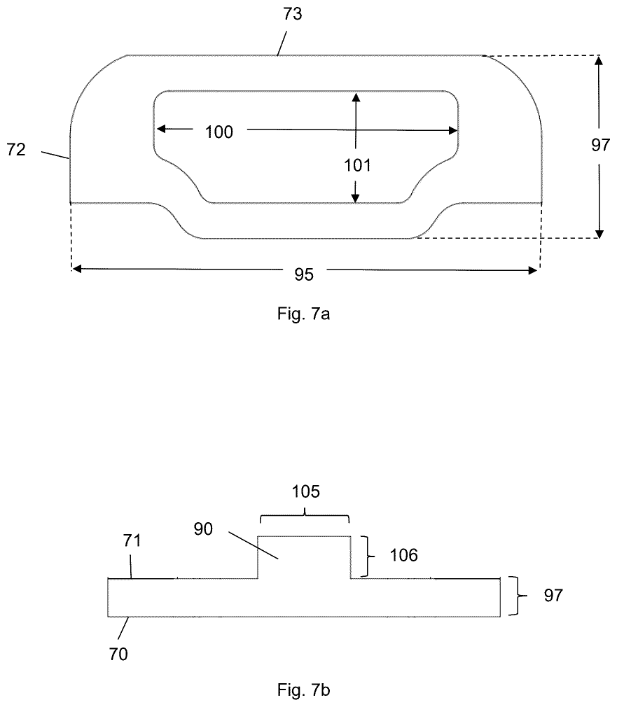

The attachment can include any suitable dimensions. For example, the attachment can include length and/or height 95, 97, respectively, of about 0.25-2 inches, as shown in FIG. 7a. The attachment can therefore have a length and/or height of at least about (or no more than about) 0.25, 0.5, 0.75, 1, 1.25, 1.5, 1.75, or 2 inches. The attachment also includes width 97 of about 0.1-0.5 inches (e.g., at least/no more than about 0.1, 0.2, 0.3, 0.4, or 0.5 inches), as shown in FIG. 7b.

Opening 80 can have any suitable dimensions, such as length 100 and width 101 of about 0.25-1.75 inches (e.g., at least/no more than about 0.25, 0.5, 0.75, 1, 1.25, 1.5, or 1.75).

Ledge 90 can include length 105 and width 106 of about 0.1-1 inches (e.g., at least/no more than about 0.1, 0.2, 0.3, 0.4, 0.5, 0.6, 0.7, 0.8, 0.9, or 1 inch).

Apparatus 20 can be constructed from any suitable material, such as (but not limited to) metal (e.g., stainless steel), plastic, rubber, composites, or combinations thereof. Thus, the materials used to construct the apparatus can be strong and configured to withstand breakage.

In some embodiments, the apparatus can include one or more insulating materials, such as foam. The insulating material or materials can provide thermal insulation to protect the communications port from external temperatures, as well as providing a padded characteristic.

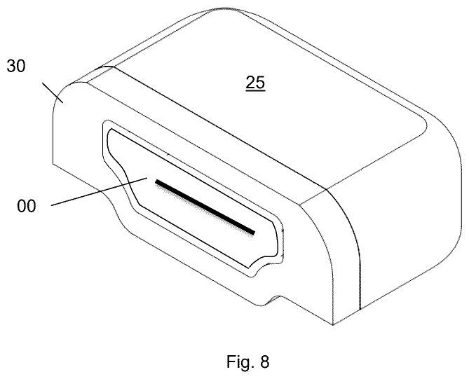

In use, communications port 20 can be positioned within cavity 20 of the housing. Specifically, the port can rest on ledge 90 with the sides of the port contacting the sides of the housing. The housing therefore provides a surrounding element to protect and cushion the support. Attachment 30 can then be positioned on the front face of the housing by inserting the attachment projections into the housing apertures, thereby retaining the port within the cavity. Opening 80 of the attachment is sized and shaped to allow a user access to the port, as shown in FIG. 8. The apparatus can be removed if desired by a user.

The disclosed protective apparatus provides several advantages for users. For example, apparatus 20 extends around and supports a corresponding communications port 20, thereby protecting the port in the case of accidental bumps or drops of the electrical device.

Protective apparatus 20 is easy to use, such that even children or the elderly can enjoy the benefits of the apparatus.

Apparatus 20 is relatively inexpensive to manufacture.

The disclosed apparatus may be used without making any significant changes to the communications port or associated electronic device.

The apparatus can serve as a shock-absorbing element, thereby protecting the communications port. Thus, if the electronic device is subjected to potentially harmful levels of vibration (e.g., being dropped or being used in a vehicle in motion), the apparatus can prevent the port from being damaged.

The protective apparatus may be applied to and used in conjunction with all types of portable computing devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A protective apparatus comprising:
a housing defined by a front face comprising one or more apertures, a rear face, a pair of side faces, a top face and an opposed bottom face, and a cavity that extends into an interior of the housing from the front face;
an attachment defined by a front face and an opposed rear face, the rear face comprising one or more projections aligned with the one or mor apertures of the housing, a pair of side faces, a top face and an opposed bottom face, and an opening that extends through a thickness of the attachment;
wherein the bottom face of the attachment includes a lowered region comprising a ledge that extends away from the rear face of the attachment; and
wherein the housing and attachment are releasably joined together by positioning the projections in the aligned apertures.

2. The protective apparatus of claim 1, further comprising a communications port positioned within the cavity.

3. The protective apparatus of claim 1, wherein the communications port is selected from a HDMI (High Definition Multimedia Interface) port, 11. USB (Universal Serial Bus) port, or ethernet port.

4. The protective apparatus of claim 1, wherein the housing rear face includes an indentation that extends into the cavity.

5. The protective apparatus of claim 1, comprising two apertures and two projections.

6. The protective apparatus of claim 1, wherein the housing has a length and width of about 0.25-2 inches and a height of about 0.1-1 inches.

7. The protective apparatus of claim 1, wherein the ledge is positioned below the bottom face of the housing.

8. The protective apparatus of claim 1, wherein the attachment has a length and height of 0.25-2 inches and a width of 0.1-0.5 inches.

9. The protective apparatus of claim 1, wherein the ledge has a length, width, or both of about 0.1-1 inches.

10. The protective apparatus of claim 1, constructed from one or more of metal, plastic, rubber, or composite materials.

11. A method of preventing or reducing the incidence of damage to a communications port of an electronic device, the method comprising:
positioning the communications port within the cavity of the housing of the protective apparatus of claim 1;
joining the attachment to the housing by positioning the one or more attachment projections within the one or more aligned housing apertures;
whereby the communications port is surrounded by the protective apparatus and wherein the communications port can be accessed via the attachment opening.

12. The method of claim 11, wherein the electronic device is selected from a gaming console, personal computer, tablet computing device, or electronic reader.

13. The method of claim 11, wherein the communications port is selected from a HDMI (High Definition Multimedia Interface) port, 11. USB (Universal Serial Bus) port, or ethernet port.

14. The method of claim 11, wherein the communications port rests upon the ledge.

15. The method of claim 11, wherein the housing rear face includes an indentation that extends into the cavity.

16. The method of claim 11, wherein the protective apparatus comprises two apertures and two projections.

17. The method of claim 11, wherein the housing has a length and width of about 0.25-2 inches and a height of about 0.1-1 inches.

18. The method of claim 11, wherein the ledge is positioned below the bottom face of the housing.

19. The method of claim 11, wherein the attachment has a length and height of 0.25-2 inches and a width of 0.1-0.5 inches.

20. The method of claim 1, wherein the ledge has a length, width, or both of about 0.1-1 inches.
